(19) United States
(12) Patent Application Publication
(10) Pub. No.: US 2015/0178298 A1
(43) Pub. Date: Jun. 25, 2015

(54) PAGE MATCHING FOR RECONSTRUCTED APPLICATION PAGES

(71) Applicant: CAPRIZA TECHNOLOGIES I.L. LTD., HOD HASHARON (IL)

(72) Inventors: Ido Ish-Hurwitz, Kfar Saba (IL); Dror Schwartz, Holon (IL); Sagi Monza, Rishon Le Tzion (IL); Armon Ronnen, Moshav Adanim (IL)

(73) Assignee: CAPRIZA TECHNOLOGIES I.L LTD., HOD HASHARON (IL)

(21) Appl. No.: 14/134,919

(22) Filed: Dec. 19, 2013

(51) Int. Cl. G06F 17/30; G06F 17/22

(52) U.S. Cl. CPC G06F 17/3089; G06F 17/2247

(57) ABSTRACT

A method for reconstructing a sequence of pages operating on a user interactive software application displaying to a user on a display a sequence of graphic pages. The software application involves transitioning between the graphic pages. Some of said pages bear page identifiers and page transitioning graphic identifiers. A page is intercepted, the likelihood of which to resemble a reconstituted page is derived from both its page descriptor properties and transitioning properties.

### FIELD OF THE INVENTION

The present invention relates to graphically interactive programs known also as software applications, and the automatic interpretation of user activities while interacting with a computerized system.

### BACKGROUND OF THE INVENTION

The programming environment in which the present invention is implemented, relates to interactive programs (also known as software applications) in which the user is presented with a sequence of interface pages, each one at a time. Each one of the pages usually demonstrates several appended graphic entities with which the user can interact, either by receiving information or feeding information or giving direct instructions. A typical program language of the type employed for such tasks are markup languages such as HTML or XHTML.

HTML pages can be described each as a tree of elements arranged in a hierarchical order. Each page typically includes a number of elements. Attributes form a part of most elements, which contribute to the functional definitions of each element. Exemplary attributes are “id” which specifies unique id for an element; “class”, which specifies a style class in an element. Controls are specific type of elements in a page associated forms that are specifically made to interact with a user. The user interacts with forms through the mediation of the controls. Some controls have initial values and a value of the current instance. For each new instance of a program, the value of a control is reset and may be stored. The value of the control is defined typically by a “value” attribute.

In the running of an interactive program, or application as it is also called, the user begins by interacting with a page mediated by graphic entities on the page. As can be seen in FIG. 1A, graphic page 20 includes, visually, several graphic entities which are referred to later on as page associated graphic entities (PASGE). Graphic entity 22, graphic entity 26 and graphic entity 28. Graphic entity 28 can respond to the activation by the user.

### SUMMARY OF THE INVENTION

A dual mechanism is presented, that is able on the one hand to reconstruct a putative interactive program from partial evidence collected during interaction of a user with an interactive program. The interaction of the user with the reconstruction mechanism (RM) drives a flow of pages, subjected to interaction with the user. The mechanism of the invention tracks one or more instances of an interactive program, in order to acquire a set of rules to make decision regarding the likelihood of candidate pages, to fit in a specific place in one of a sequence of pages of the putative program. On the other hand, the mechanism of the invention can classify an intercepted page with respect to the reconstructed putative program by applying a classifier mechanism.

Although the mechanism of the present invention is most easily described in terms and aspects of markup languages, specifically HTML and various flavors of it, the invention is by no means limited to such mark-up computer languages. Generally, the classifier mechanism makes decisions as to equivalence of an intercepted candidate page based on two sets of cues derived from one or more sessions of interaction of a user with an interactive program. One set of cues relates to actual page identifiers and the other set of cues to page to page transitioning identifiers.

### BRIEF DESCRIPTION OF THE DRAWINGS

The present invention will be understood and appreciated more fully from the following detailed description taken in conjunction with the appended drawings in which:

FIG. 1A is a schematic drawing showing prior art structure of a page in an interactive program;

FIG. 1B is a schematic drawing showing transition between a page and the subsequent page resulting from activation of a graphic entity.

FIG. 2 is a schematic description of the sources of data for the RM showing the input streams fed into RM in the running of an instance of a page flow based interactive program.

FIG. 3A is a schematic description of a sequence of pages representing an instance of a page flow based interactive program;

FIG. 3B is a schematic description of a sequence of pages representing another instance of the above page flow based interactive program;

FIG. 4 is a schematic description of a page on which are distributed graphic constituents one of which is a HTML control element demonstrating two optional states;

FIG. 5 is a schematic description of a two page sequence showing HTML control elements;

FIG. 6 a schematic description of a page to page transition and derivation of identifiers from page and transition;

FIG. 7 is a schematic description showing grouping of identifiers taking part in the mechanism of the invention;

FIG. 8A is a schematic description showing transitioning options provided by two option only button;

FIG. 8B is a schematic description showing transitioning options provided by several option button;

FIG. 9 is a schematic description of two transitioning options leading to seemingly identical results.

### DESCRIPTION OF EMBODIMENTS OF THE INVENTION

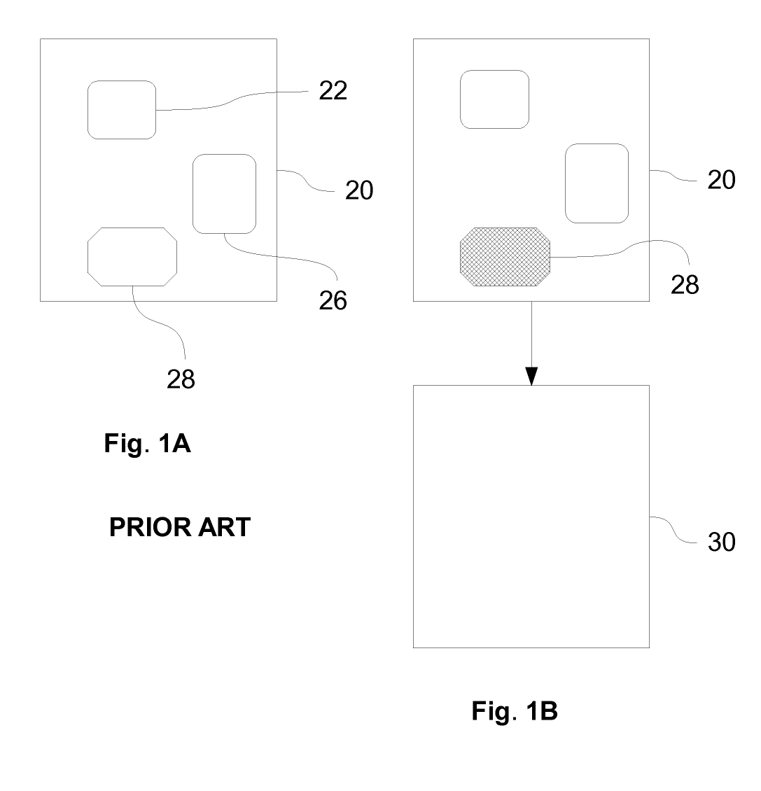

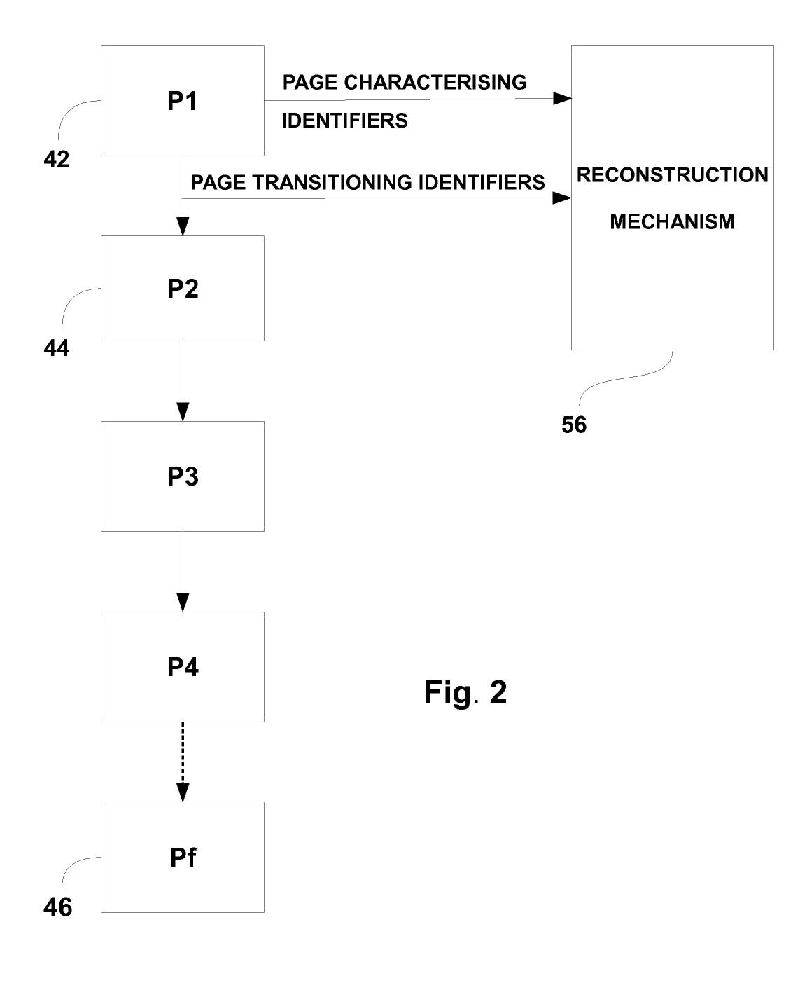

The present invention is to do with a dual mechanism for reconstructing a putative interactive program and identifying intercepted pages with respect of said reconstructed program. The putative interactive program is characterized by a flow of pages each one of which exhibiting page identifiers, this flow being driven by the interaction of the user with the interactive program. In one example illustrated schematically in FIG. 1B, graphic entity 28 on page 20 is activated by a user, as shown by hatching of graphic entity 28. The page reacts to the activation by presenting a new page to the user, in this case page 30. Page 30 has characteristics of its own including graphic entities, otherwise it would be a blank page. Page 30 may include also constituent like constituent 28, the activation of which brings forth yet another page, or presents page 20 again. Another example, illustrated in FIG. 2, a sequence of pages is shown. This sequence represents an instance of a page-flow based interactive program (PFIP), in which each page is displayed on the screen, for the purpose of being observed showing its PASGEs and possibly responded to by the user. In this example the sequence of pages is linear and shows no branching or other types of branching. However, the entire interactive program (EIP) permits different arrangements and sequences of pages, since the graphic entity (one or more), that provide for the transitioning from one page to the next one, may provide for different transitioning directions. In the present example, P1 i.e. page 42, transitions to page 44 because a graphic entity that the activation of which causes the passage to page 44 would in a different instance possibly cause a transit to page x. However, in the present example of an instance, the sequence initiates with a certain page 42 and ends in page 46. The reconstruction mechanism (RM) is capable of tracking the pages in an instance of the PFIP, extract for each page characterizing identifiers and page transitioning identifiers. As can be seen, schematically still in FIG. 2, RM 56 collects page characterizing identifiers and page transitioning identifiers. These constitute the two input data sets for the RM. The nature of these two data sets used for input will be discussed below.

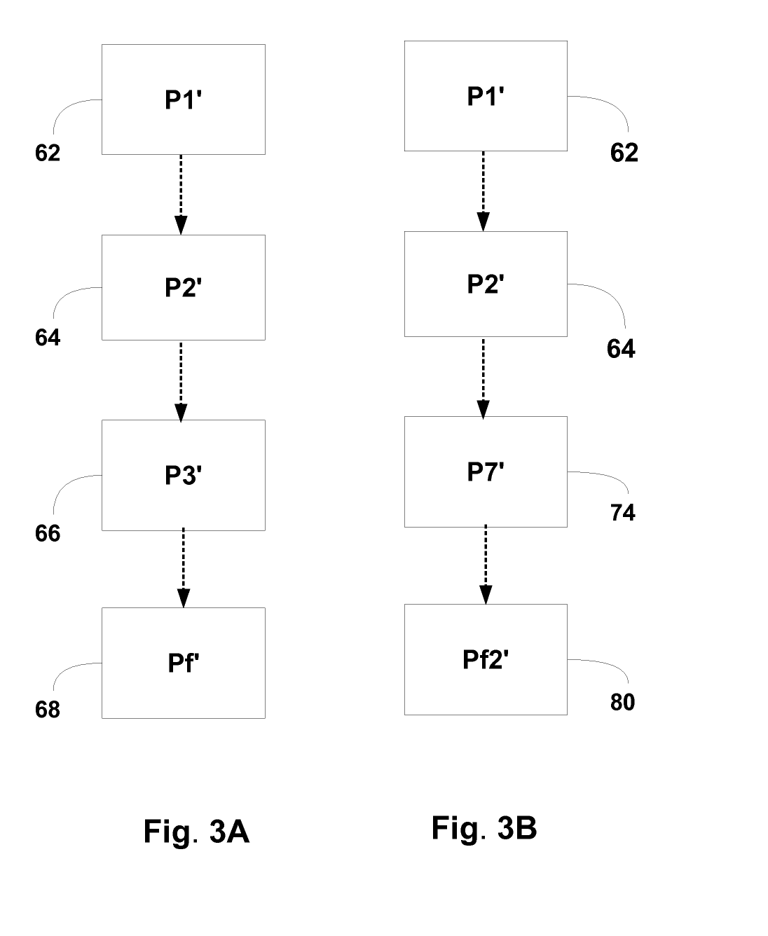

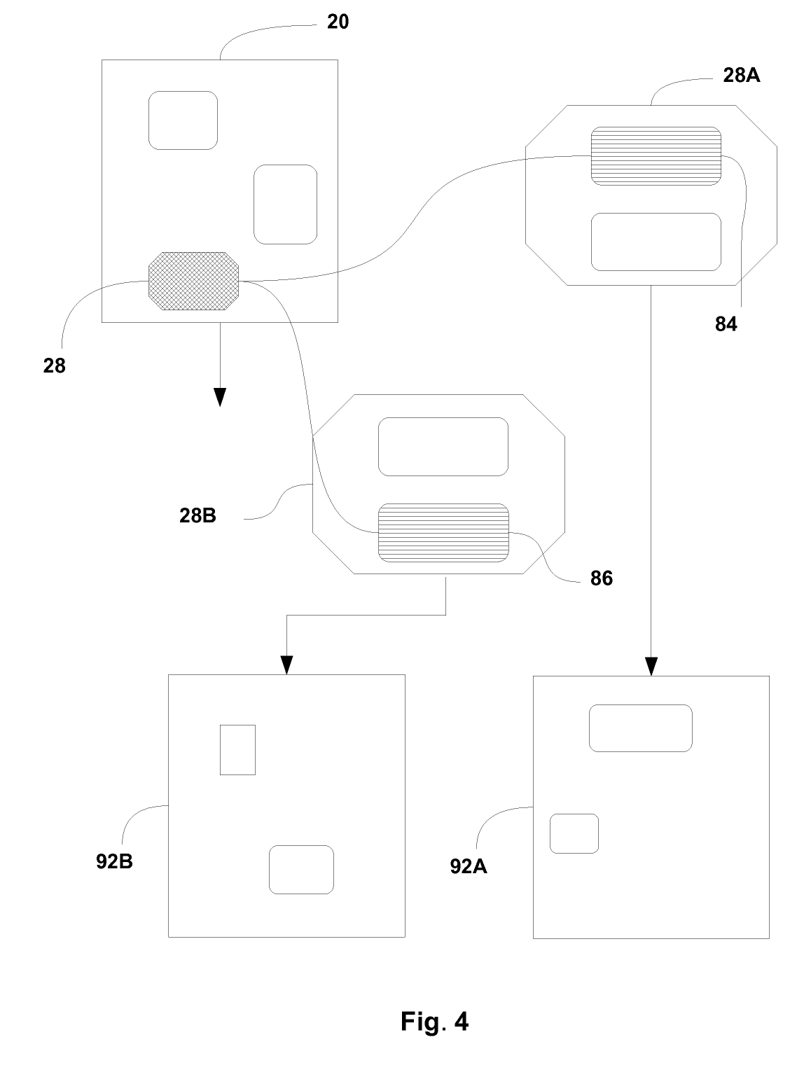

In the background, the RM constructs a synthetic version of the EIP, hereinafter referred to as a reconstructed EIP (REIP), supervised by a user, making the reconstruction in this embodiment a supervised reconstruction. In order to explain some aspects of the training which takes place in the reconstruction, reference is made to FIGS. 3A and 3B. In FIG. 3A page 62, which is the first page of the REIP is gives rise to page 64, which gives rise to page 66 giving rise to 68, last page. This sequence is a reconstruction of an EIP based upon one instance of EIP executed by RM and supervised by a user. In FIG. 3B, another instance of EIP is executed, forming another sequence of pages, i.e. pages 62, giving rise to page 64, giving rise to page 74 which finally, gives rise to page 80. Looking at FIGS. 3A and 3B it is evident that page 64 (P2′) are identical. However they are identical with respect to the fact that their contents as judged by RM are identical. The reason that at one instance the resulting page subsequent to page P2′ is page P3′ and at another instance the resulting, subsequent page is page P7′ is because a different interaction took place, differing the instance in FIG. 3A from the instance in FIG. 3B. Further down the sequence, page Pf′ and Pf2′ appear, respectively. It may however be found that they are identical. In practical terms, a reconstruction of the EIP is made by RM based on the supervised training as mentioned above. Reverting to page 20 in the EIP, graphic constituent 28 stands in the next sample illustrated in FIG. 4 for a HTML control. A control in a HTML page is a type of element with which the user may interact in several ways depending on the type of control and modifiers. Thus, graphic constituent 28 is in this example is a control element such as a menu element. Control element 28 can display in this example one of two optional subunits from which the user can make a selection. In the 28A option the user selects item 84 to activate and in the 28B option the user selects item 86 and further activates it. The page that appears as a consequence of the interaction of the user with control element 28 option 28A, namely page 92A may be different than page 92B that is obtained as a result of selecting option 28B (item 86). One possibility is that if the user activates item 84 a succession of pages will ensue which is different than the succession of pages ensued if the user will have activated item 86. In order to fully reconstruct the EIP, the training should preferably take into consideration both option.

As briefly referred to above, the RM collects page identifiers to characterize the pages and other class of identifiers to characterize transition between pages. The two classes of identifiers, the page identifiers and the transitioning identifiers are used as input for the RM as such without further investigating their functionality. For example referring to page 20 in FIG. 1A again, some page identifiers of constituent 28 are associated with the capability of the activation of constituent 28 in such a way as to bring about the presentation of page 30.

Tracking HTML EIP 118 as an Example

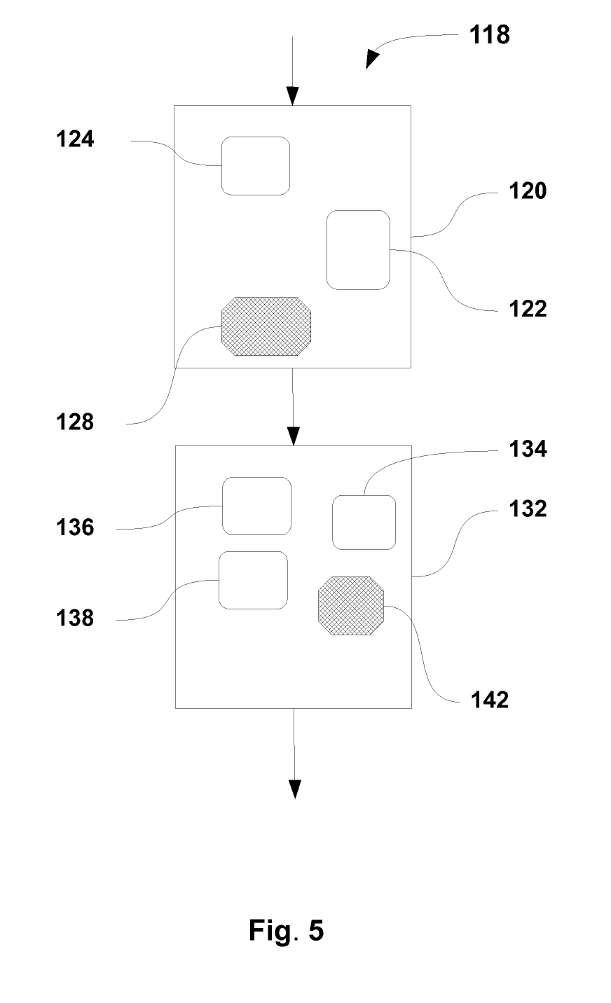

Referring to FIG. 5, as the RM constructs the REIP, tracking an instance of the EIP, HTML EIP 118 constitutes a sequence of web pages. Page 120 of EIP 118 contains several graphic constituents. Constituent 122 is an HTML element, having an attribute bearing a specific value. Constituent 124 is an HTML element having an attribute bearing a specific value. Constituent 128 is a control type HTML element having an attribute bearing a specific value, the term value may relate to a range as well. In the instance of EIP 118, now tracked, the activation of constituent 128 brings about page 132. Associated with this subsequent page are graphic constituents 134, 136 and 138. Constituent 142 is a control type HTML element, the activation of which will bring about the next page in the sequence of pages of the current instance of EIP 118. As the RM accumulates the information in the current instance of EIP 118, Page 120 will have associated a list of attributes of the page characterizing type, and one or more attributes of the page transitioning type. The RM, having tracked one instance of a EIP, cannot obtain all the characteristic features of the pages transitioned. However at this stage, the classifier mechanism can perform a task with a lesser degree of certainty compared to what it would have achieved were several instances of the EIP tracked.

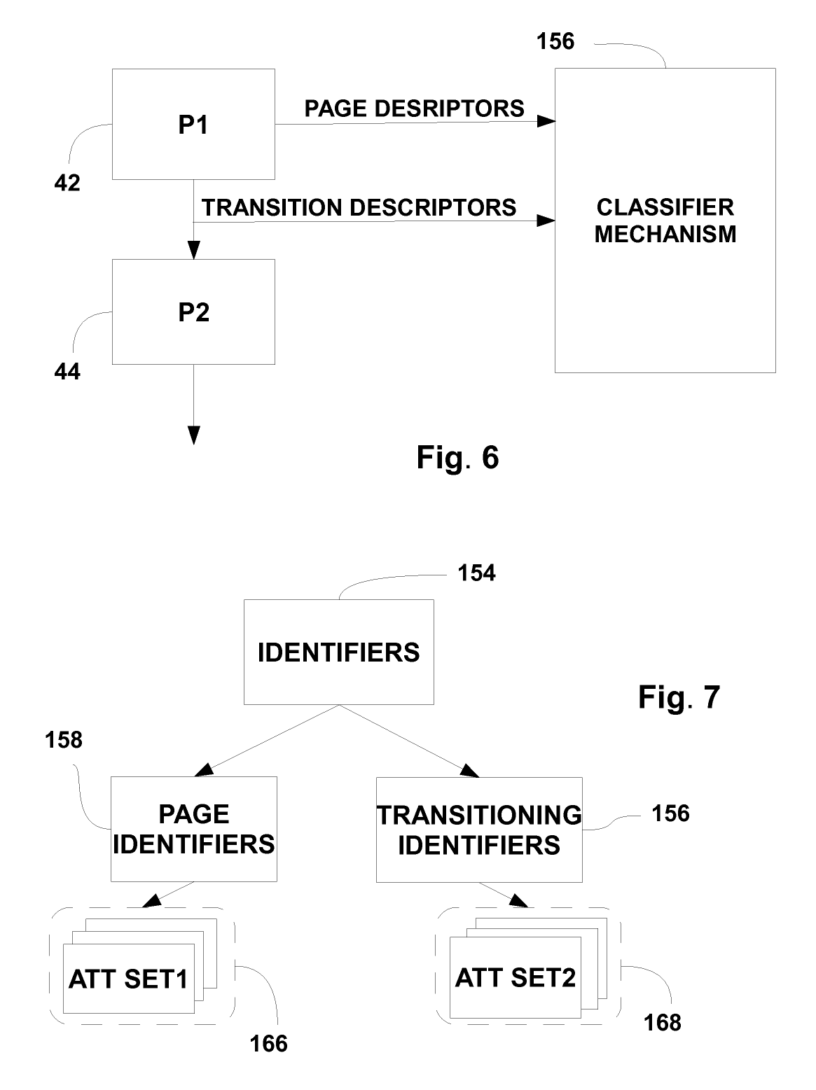

Referring to FIG. 6, continuing the present scenario, page identifiers of each page are collected during the tracking by the a memory device accessible by the RM, and the page identifiers (of the two types, page identifiers and transition identifiers) are kept in a memory as well. A hierarchical classified grouping of identifiers is constructed for each page as described schematically in FIG. 7. Generally identifiers 154 belong to either subgroup 156 (transition identifiers), or page identifiers 158. Page identifiers are typically various attributes 166, in this example, attribute type 1, type 2 or other types. Attributes 168 are derived from various control elements in the pages of the REIP, or any other attributes which relate to an identification of transitioning between pages.

### Another Example

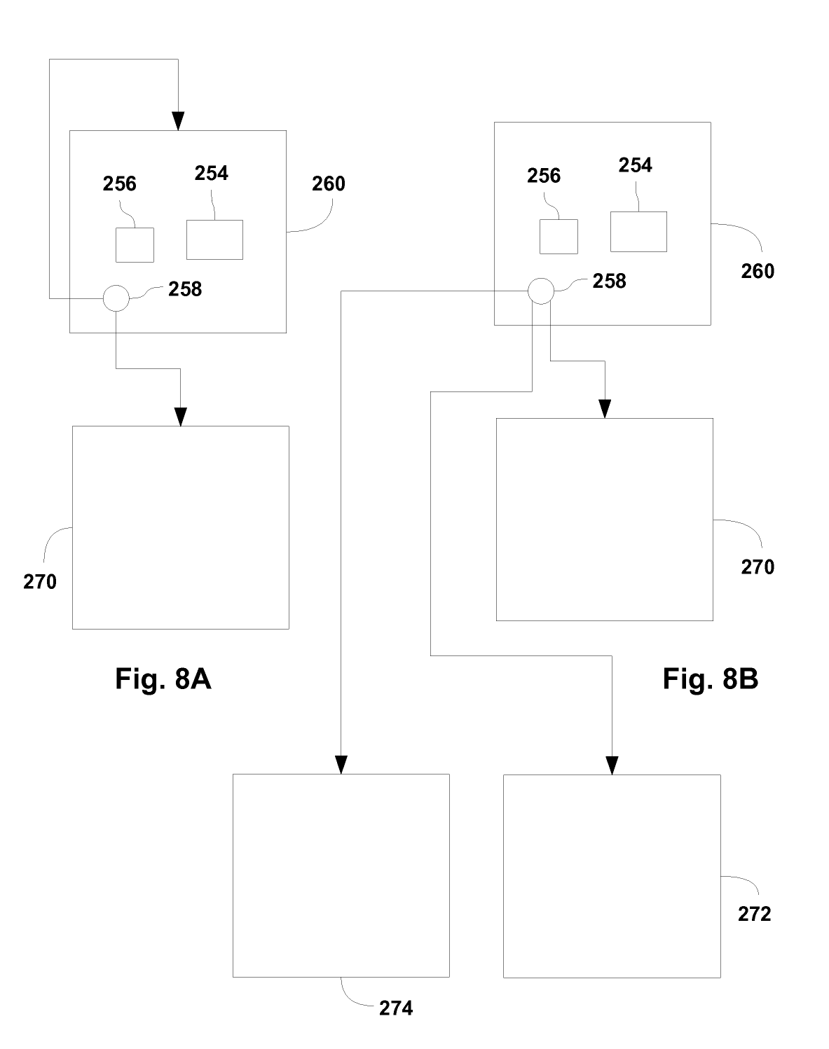

In FIG. 8A another example is presented in which elements 254, 256 and 258 are displayed on page 260, Element 258 is a control element known as “button”, which is used to login to a website. If the login is successful, transitioning from page 260 will take place to page 270. On the other hand if login fails, the user will be redirected to page 260. In FIG. 8B element 256 is a “menu” which facilitates many transitioning options, such as to page 270, to page 272 or to page 274.

### Determining Intercepted Page Equivalence

As briefly mentioned above, the intercepted page classifier (IPC) receives (intercepts) pages and has to make a decision as to which of the pages of the EIP the intercepted page matches (or is equivalent to). The IPC implements one or more decision rules which may be selected for a specific task. The IPC can access the REIP, and receive the identifiers as shown in FIG. 7. The IPC can decide based on accumulation of cues. For example if reconstructed page A has more attributes identical to the accumulative number of attributes on reconstructed page N in the REIP with respect to an intercepted page, the likelihood of equivalence is increased. Another aspect in the way the IPC works is the weight the transitioning aspect is given as compared to the actual page identifiers is/are given.

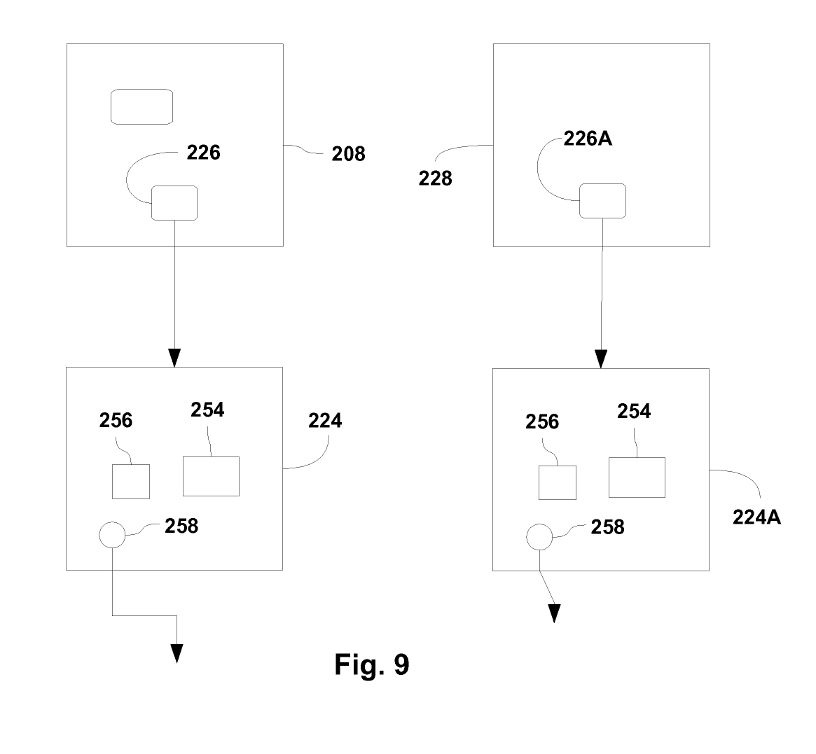

Referring to FIG. 9 an ambiguity exists between two page identifications with regards to their respective matching with an intercepted page. The ambiguity is solved by their respective transitioning properties. Thus, as in the REIP, page 208 transitions to page 224 when control 226 is activated. Page 228 having a control 226A, transitions into page 224A when the control is activated. Pages 224 and 224A appear identical, having both identical set of elements 254, 256 and 258 are displayed on page 260, although it is assumed that they may not be identical because their identification has not been fully realized. However, as an intercepted page may be identifiable page—wise with either 224 or 224A, the preceding page in the REIP may solve the ambiguity, If the preceding page was more like page 208 than page 228, the likelihood of the intercepted page to be an equivalent of page 224.

In a special case of the intercepted page classifier (IPC) deciding on the equivalence of an intercepted page, no match is found, and the intercepted page is altogether refuted. In other words, if the likelihood of an intercepted page to match with any of the reconstructed pages is below a certain value, the page has no match.

1. A method for reconstructing a sequence of pages operating on a user interactive software application displaying to a user on a display a sequence of graphic pages, said application involving transition between at least some of said graphic pages, wherein at least some of said pages bear page identifiers and page transitioning graphic identifiers, said method comprising:
tracking at least one instance of a page-flow based interactive program;
keeping in memory two sets of identifiers, one set is a set of page identifiers, for each page in the reconstructed program, and another set of identifiers which a set of transitioning between pages.

2. A reconstruction mechanism as in claim 1 wherein said pages are created using a markup language.

3. A method for determining the likelihood of equivalence of a candidate page with any page of a reconstructed sequence of pages as implemented by the method in claim 1, said method comprising:
intercepting a candidate page;
subjecting said intercepted page to a page classifier which compares the identifiers of said page with the identifiers of each of the pages of the reconstructed program, and
wherein said page classifier implements a decision rule to decide which of the pages of said reconstructed program is a most likely match for said intercepted page.

4. A method for determining the equivalence of a candidate page with any page of a reconstructed sequence of pages as implemented by the method in claim 1, said method comprising:
intercepting a candidate page;
subjecting said intercepted page to a page classifier which compares the identifiers of said page with the identifiers of each of the pages of the reconstructed program, and
wherein said page classifier implements a decision rule refuting the equivalence of said intercepted page with any of said reconstructed pages.
